(19) United States
(12) Patent Application Publication
(10) Pub. No.: US 2010/0138279 A1
(43) Pub. Date: Jun. 3, 2010

(54) BRAND SUSTAINABILITY INDEX

(76) Inventor: Elizabeth Heller Cohen, St. Louis, MO (US)

Correspondence Address: WENDELL RAY GUFFEY;NESTLE PURINA PETCARE GLOBAL RESOURCES, INC., 1 CHECKERBOARD SQUARE, 11-T, ST. LOUIS, MO, 63164, US

(21) Appl. No.: 12/452,977

(22) PCT Filed: Jul. 30, 2008
(86) PCT No.: PCT/US08/09166

§ 371 Date: Jan. 29, 2010

Related U.S. Application Data
(60) Provisional application No. 60/959,344, filed on Aug. 2, 2007.

(51) Int. Cl. G06Q 10/00

(52) U.S. Cl. 705/10

(57) ABSTRACT

A system and method for determining a composite rating for sustainability for a brand are provided. The method comprises selecting sustainability factors applicable to the brand. For each applicable sustainability factor, selecting an activity that is an attribute of the brand and determining a score for each selected activity. The method then calculates a composite rating for the brand based on the score for each selected activity. The method then displays the composite rating for the brand and the score for each selected activity in a graphic format.

### CROSS REFERENCE TO RELATED APPLICATIONS

This application is a national stage application under 35 U.S.C. §371 of PCT/US2008/009166 filed Jul. 30, 2008, which claims priority to U.S. Provisional Application Ser. No. 60/959,344 filed Aug. 2, 2007, the disclosures of which are incorporated herein by this reference.

### BACKGROUND OF THE INVENTION

1. Field of the Invention

The present invention relates generally to systems and methods for improving the rating for a brand and particularly to systems and methods for determining a composite rating for sustainability of a brand.

2. Description of the Related Art

Currently, a company is rated on its sustainability, such as, environmental, economic, social support of developing communities, and the like. However, a brand, such as, a consumer product, service, and the like, that the company produces is not rated on a composite that includes the range of sustainability measures. Without the composite for the brand, it is difficult to increase awareness and encourage action to improve at the brand level.

Some retailers are pushing for companies to include a carbon dioxide (CO2) number on the outside of each brand or package. This will begin to get brands to consider making changes to get possible sales reward, but it still does not get a brand owner to understand the position of its brand in relation to the position of competing brands in a true sustainable measure—CO2 is a one dimensional measure. Other retailers are pushing for a “Packaging Scorecard”—this too is a one dimensional measure. To improve the world's climate change situation, brand leaders need to understand and measure the effect that a change to a brand will have on improving the sustainability position of the brand on many different attributes.

Thus, there is a demand for a system and method for determining a composite rating for sustainability of a brand. The composite rating quickly brings awareness and action to the decision-makers of the important brands in our society within the largest businesses. With climate change accelerating, and the need for business leaders to quickly understand how to change their brands and which actions to take to improve the planet and their business actions, this composite rating, or Brand Sustainability Index, is a motivator and accelerator for education and action of business brand leaders. The presently disclosed system and method for determining a composite rating for sustainability of a brand satisfies these demands.

### SUMMARY OF THE INVENTION

It is, therefore, an object of the present invention to improve the rating for a brand by determining a composite rating for sustainability of the brand.

It is a further object of the invention to provide a system and computer program for determining a composite rating for sustainability for a brand.

It is yet a further object of the invention to provide a method for determining a composite rating for sustainability for a brand. The method comprises selecting sustainability factors applicable to the brand. For each applicable sustainability factor, selecting an activity that is an attribute of the brand and determining a score for each selected activity. The method then calculates a composite rating for the brand based on the score for each selected activity. The method then displays the composite rating for the brand and the score for each selected activity in a graphic format.

Other and further objects, features, and advantages of the present invention will be readily apparent to those skilled in the art.

### BRIEF DESCRIPTION OF THE DRAWINGS

FIG. 1 is a block diagram that illustrates the hardware and software components comprising an exemplary embodiment of a computing system for determining a sustainability index for a consumer brand.

FIG. 2 illustrates an exemplary embodiment of a general form of a matrix for determining a sustainability index for a consumer brand.

FIG. 3A illustrates an exemplary embodiment of a display of a sustainability index for a consumer brand.

FIG. 3B illustrates another exemplary embodiment of a display of a sustainability index for a consumer brand.

FIG. 4 is a flow diagram that illustrates an exemplary embodiment of a method for determining a composite rating for sustainability of a brand to illustrate one exemplary embodiment of the brand sustainability index program 141.

### DETAILED DESCRIPTION OF THE INVENTION

### Embodiments of the Invention

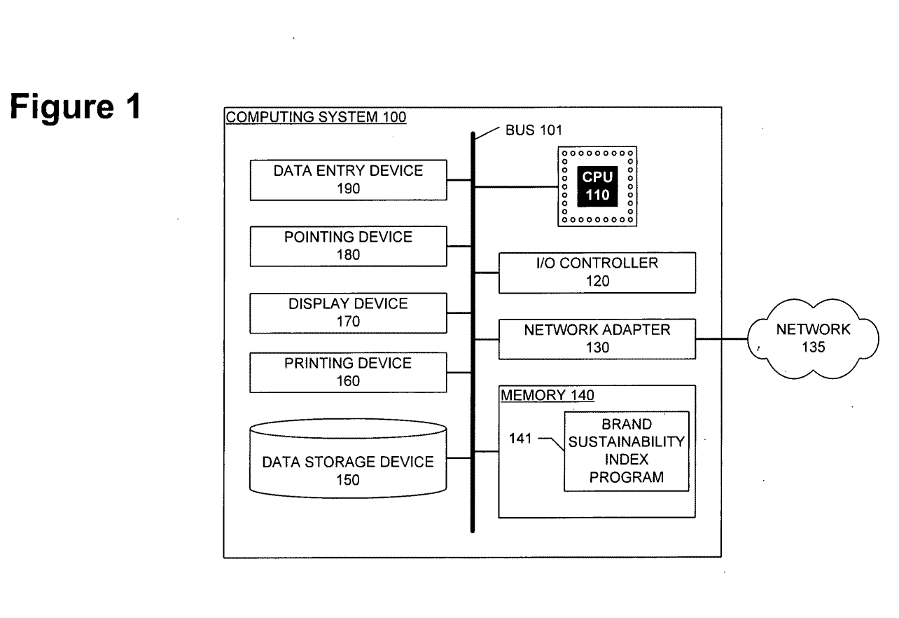

FIG. 1 is a block diagram that illustrates the hardware and software components comprising an exemplary embodiment of a computing system for determining a sustainability index for a consumer brand. The computing system 100 is a general-purpose computer. Bus 101 is a communication medium that connects a central processor unit (CPU) 110, an input/output (I/O) controller 120, and a network adapter 130 to a memory 140. The network adapter 130 also connects to a network 135 and is the mechanism that facilitates the passage of network traffic between the computing system 100 and the network 135. The CPU 110 performs the disclosed methods by executing the sequences of operational instructions that comprise each computer program resident in, or operative on, the memory 140. In one embodiment, the computing system 100 includes a web server that allows other computers on the network 135 to access documents stored on the computing system 100.

The bus 101 is also the communication medium that connects the I/O controller 120 to I/O devices, including, a data storage device 150 (e.g., a hard drive, portable drive, or the like), a printing device 160 (e.g., a printer, plotter, or the like), a display device 170, a pointing device 180 (e.g., a mouse, track ball, pen device, touch screen, or the like), and a data entry device 190 (e.g., a keyboard, touch screen, or the like). The computing system 100 may include additional I/O devices, as desired. The data storage device 150 shown in FIG. 1 is an internal data storage device. It is to be understood however, that in another embodiment the data storage device 150 may be external to the computing system 100 and accessible via a network connection.

In one embodiment, the configuration of the memory 140 in the computing system 100 includes, in addition to the necessary operating system and application programs (not shown), a brand sustainability index program 141. The programs that run in the memory 140 store intermediate results in the memory 140 and transmit final results either via the bus 101 for storage in the data storage device 150, or via the network adapter 130 for storage in a network storage device (not shown) or processing by another system or program. It is to be understood that in another embodiment the configuration of the memory 140 may not simultaneously include these programs. The CPU 110 coordinates loading a program when it is needed, storing intermediate results, transferring data from one program to another, and unloading the program when it is no longer needed.

The network 135 shown in FIG. 1, in an exemplary embodiment, is a public communication network. The computing system 100 also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA) or Code Division Multiple Access (CDMA) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

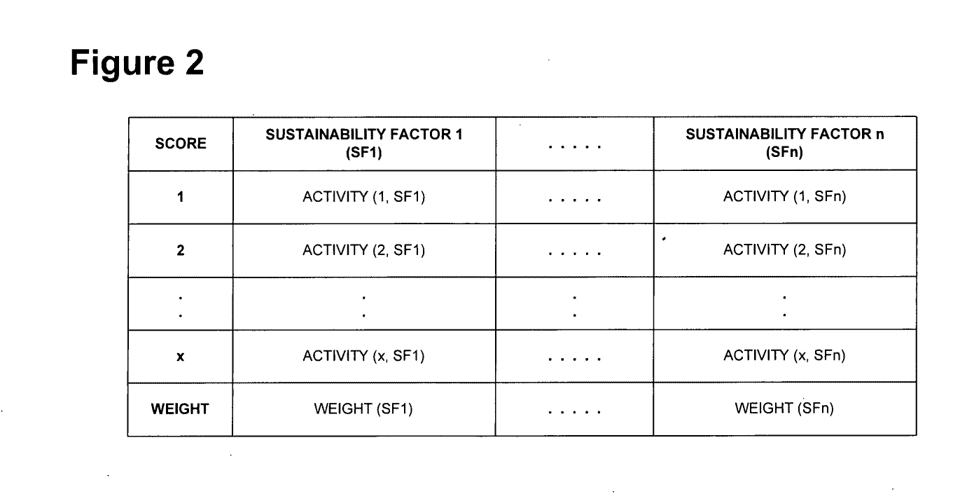

FIG. 2 illustrates an exemplary embodiment of a general form of a matrix for determining a sustainability index for a consumer brand. The matrix shown in FIG. 2 is a weighted nxx matrix. The matrix includes n sustainability factors, SF1 through SFn. Each sustainability factor includes x activities and a weighting factor. The activities are ranked from lowest to highest and assigned a score between one (1) and x, where one (1) is the lowest score and x is the highest score. If one of the activities associated with a sustainability factor apply to the consumer brand, the score assigned to the activity is an input for the brand sustainability index program 141 which computes the sustainability index for the consumer brand. The weighting factor provides a mechanism for adjusting the score for the sustainability factor associated with the weighting factor based on the importance, or lack of importance, of the associated sustainability factor-compared to the remaining sustainability factors.

In an exemplary embodiment of the general form of the weighted matrix shown in FIG. 2, the nxx matrix includes twenty (n=20) sustainability factors and, associated with each sustainability factor, ten (x=10) activities, a weighting factor, and a score. The sustainability factors encompass a number of dimensions, such as, environmental factors, social factors, economic factors, and the like. The activities are ranked from lowest to highest and each activity is assigned a score between one (1) and ten (10), where one (1) is the lowest score and ten (10) is the highest score. The brand team for the consumer brand determines which sustainability factors apply to the consumer brand. In one embodiment, the calculation of the brand sustainability index is based on the selection of one activity for each sustainability factor. In various other embodiments, since every sustainability factor may not apply to the consumer brand, the calculation of the brand sustainability index, and the choice of output format, may require the brand team to select at least one, at least two, or at least three sustainability factors. In some situations, at least four, five, six, seven, eight, or more sustainability factors may be used. For each sustainability factor that applies to the consumer brand, the brand team selects one of the activities that can be attributed to the consumer brand. The score associated with the activity attributed to each sustainability factor is an input for the brand sustainability index program 141. The brand team uses the weighting factor associated with each sustainability factor to adjust the score for the associated sustainability factor associated based on the importance, or lack of importance, of the associated sustainability factor compared to the remaining applicable sustainability factors. For example, if a sustainability factor is important, a weighting factor, for example, of 150% may be used to increase the actual score by 50% before computing the brand sustainability index. Conversely, a weighting factor, for example, of 50% may be used to decrease the actual score by 50% before computing the brand sustainability index. Table 1 illustrates the twenty (20) sustainability factors, ten (10) activities associated with each sustainability factor, and the score associated with each activity for this exemplary embodiment. It is to be understood that the sustainability factors and associated activities and scores included in the table 1 are exemplary and that another brand may modify these sustainability factors or activities to add other sustainability factors and/or activities.

TABLE 1

| Sustainability Factor | Associated Activity | Score |
|---|---|---|
| Ingredient Sourcing | Not Specific | 1 |
| Ingredient Sourcing | Brand Team Knowledge | 2 |
| Ingredient Sourcing | Conventional Ingredients | 3 |
| Ingredient Sourcing | One Natural/Select Ingredient | 4 |
| Ingredient Sourcing | Multiple Natural/Select Ingredients | 5 |
| Ingredient Sourcing | Specific Care Sources | 6 |
| Ingredient Sourcing | Organic/Fair Trade/Industry Friendly | 7 |
| Ingredient Sourcing | Industry Specific Ingredient | 8 |
| Ingredient Sourcing | Family Farms | 9 |
| Ingredient Sourcing | Back to Specific Source | 10 |
| Ingredient Transport | Average Transport | 1 |
| Ingredient Transport | Brand Team Knowledge | 2 |
| Ingredient Transport | Air Freight Needed | 3 |
| Ingredient Transport | Multiple Transports | 4 |
| Ingredient Transport | Multiple Country | 5 |
| Ingredient Transport | Single Country | 6 |
| Ingredient Transport | Single Transport | 7 |
| Ingredient Transport | Within 1000 Miles of Factory | 8 |
| Ingredient Transport | Within 500 Miles of Factory | 9 |
| Ingredient Transport | Close to Factory | 10 |
| Agricultural Support | General Farm Methods | 1 |
| Agricultural Support | Brand Team Knowledge | 2 |
| Agricultural Support | Knowledge Link to Company Programs | 3 |
| Agricultural Support | Key Ingredient Issue Awareness | 4 |
| Agricultural Support | Key Farm Technique Issue Awareness | 5 |
| Agricultural Support | Company Part of Agricultural Consortium such as | 6 |
| | SAI | |
| Agricultural Support | Brand Involved in Industry Issues | 7 |
| Agricultural Support | Brand Involved in Cocoa Consortium | 8 |
| Agricultural Support | Brand Involved in Coffee Consortium | 9 |
| Agricultural Support | Brand Gives Specific Support to Growers | 10 |
| Production Green House | Average Production | 1 |
| Gas (GHG) Carbon | | |
| Footprint | | |
| Production Green House | Brand Team Knowledge | 2 |
| Gas (GHG) Carbon | | |
| Footprint | | |
| Production Green House | Factory Figures Available | 3 |
| Gas (GHG) Carbon | | |
| Footprint | | |
| Production Green House | Assessment of Contributors | 4 |
| Gas (GHG) Carbon | | |
| Footprint | | |
| Production Green House | Engineering Assessment Options | 5 |
| Gas (GHG) Carbon | | |
| Footprint | | |
| Production Green House | Lowest Quartile of Company Brands | 6 |
| Gas (GHG) Carbon | | |
| Footprint | | |
| Production Green House | Second Quartile of Company Brands | 7 |
| Gas (GHG) Carbon | | |
| Footprint | | |
| Production Green House | Third Quartile of Company Brands | 8 |
| Gas (GHG) Carbon | | |
| Footprint | | |
| Production Green House | Top Quartile of Company Brands | 9 |
| Gas (GHG) Carbon | | |
| Footprint | | |
| Production Green House | Lowest GHG/Carbon Footprint | 10 |
| Gas (GHG) Carbon | | |
| Footprint | | |
| Energy Usage | General Energy | 1 |
| Energy Usage | Brand Team Knowledge | 2 |
| Energy Usage | Assess Heat Times/Extrusion/Processing | 3 |
| Energy Usage | Engineering Input on Energy | 4 |
| Energy Usage | Options Considered | 5 |
| Energy Usage | Lowest Quartile of Company Brands | 6 |
| Energy Usage | Second Quartile of Company Brands | 7 |
| Energy Usage | Third Quartile of Company Brands | 8 |
| Energy Usage | Top Quartile of Company Brands | 9 |
| Energy Usage | Highest Energy Efficiency/Best Footprint of | 10 |
| | Competitors' Brands | |
| Water Stewardship | Average Usage | 1 |
| Water Stewardship | Brand Team Knowledge | 2 |
| Water Stewardship | Understanding of Water for Inputs | 3 |
| Water Stewardship | Understanding of Water to Produce | 4 |
| Water Stewardship | Understanding of Water At/Near Factory | 5 |
| Water Stewardship | Lowest Quartile of Company Brands | 6 |
| Water Stewardship | Second Quartile of Company Brands | 7 |
| Water Stewardship | Third Quartile of Company Brands | 8 |
| Water Stewardship | Top Quartile of Company Brands | 9 |
| Water Stewardship | Least Usage Competitive Brands | 10 |
| Primary Packaging | Package Arrives at Shelf in Good Condition for | 1 |
| Material | Sale | |
| Primary Packaging | Package Meets Retailer and Consumer Needs | 2 |
| Material | | |
| Primary Packaging | Brand Team and Finance Review Source | 3 |
| Material | Reduction | |
| Primary Packaging | Brand Team Reviews Disposal “End of Life” | 4 |
| Material | Packaging Issues/Needs | |
| Primary Packaging | Damage Assessment of Alternative Material | 5 |
| Material | Options | |
| Primary Packaging | Brand Team and/or Consumer Input on | 6 |
| Material | Alternative Materials | |
| Primary Packaging | Competitive Assessment of Material Options and | 7 |
| Material | CO₂ Issues | |
| Primary Packaging | 3 Year Future Scenario Based on UK/California | 8 |
| Material | Packaging Trends | |
| Primary Packaging | Test of Alternative Packaging/Source Reductions | 9 |
| Material | | |
| Primary Packaging | Preferred Package Material/Source Amount than | 10 |
| Material | Competition | |
| Primary Packaging Source | Current Standards Acceptable to Retail and | 1 |
| Reductions | Consumer | |
| Primary Packaging Source | Brand Team Knowledge of Last Reduction | 2 |
| Reductions | | |
| Primary Packaging Source | Brand Team Knowledge of Options to Reduce | 3 |
| Reductions | | |
| Primary Packaging Source | Financial Assessment of Reduction | 4 |
| Reductions | | |
| Primary Packaging Source | Damage Assessment of Reduction | 5 |
| Reductions | | |
| Primary Packaging Source | Consumer Insight into Source Reduction/CO₂ | 6 |
| Reductions | Reduction | |
| Primary Packaging Source | Competitive Assessment of Source Reduction | 7 |
| Reductions | | |
| Primary Packaging Source | 3 Year Future Scenario Based on UK/California | 8 |
| Reductions | Packaging Trends | |
| Primary Packaging Source | SWOT Analysis of Primary Packaging Source | 9 |
| Reductions | Reduction | |
| Primary Packaging Source | Less Material Usage than Competition | 10 |
| Reductions | | |
| Secondary Packaging | Package Arrives at Shelf in Good Condition for | 1 |
| Material | Sale | |
| Secondary Packaging | Brand Team Reviews All Secondary/Shipping | 2 |
| Material | Material | |
| Secondary Packaging | Brand Team and Finance Review | 3 |
| Material | Casing/Overwrap Reduction Options | |
| Secondary Packaging | Brand Team/Finance Review Disposal “End of | 4 |
| Material | Life” Packaging Issues/Needs | |
| Secondary Packaging | Damage Assessment of Material Options | 5 |
| Material | | |
| Secondary Packaging | Brand Team and/or Retailer Input on Material | 6 |
| Material | Options | |
| Secondary Packaging | Competitive Assessment of Material Options and | 7 |
| Material | CO₂ Issues | |
| Secondary Packaging | 3 Year Future Scenario Based on UK/California | 8 |
| Material | Packaging Trends | |
| Secondary Packaging | SWOT Analysis of Secondary Package | 9 |
| Material | Sustainability | |
| Secondary Packaging | Preferred Material/Source Amount to | 10 |
| Material | Competition | |
| Secondary Package Source | Current Standards Acceptable to Retailer | 1 |
| Reduction | | |
| Secondary Package Source | Brand Team Knowledge of Last Reduction | 2 |
| Reduction | | |
| Secondary Package Source | Brand Team Knowledge of Options to Reduce | 3 |
| Reduction | | |
| Secondary Package Source | Financial Assessment of Reduction | 4 |
| Reduction | | |
| Secondary Package Source | Damage Assessment of Reduction | 5 |
| Reduction | | |
| Secondary Package Source | Retailer Insight into Source Reduction/CO₂ | 6 |
| Reduction | Reduction | |
| Secondary Package Source | Competitive Assessment of Source Reduction | 7 |
| Reduction | | |
| Secondary Package Source | 3 Year Future Scenario Based on UK/California | 8 |
| Reduction | Packaging Trends | |
| Secondary Package Source | SWOT Analysis of Secondary Packaging Source | 9 |
| Reduction | Reduction | |
| Secondary Package Source | Less Material Usage than Competition | 10 |
| Reduction | | |
| Supply Chain | Average Supply Chain Issues | 1 |
| Supply Chain | Brand Team Knowledge of | 2 |
| | Package/Energy/Transport from First Inputs to | |
| | Shelf | |
| Supply Chain | Brand Map of Supply Chain Sustainability Pain | 3 |
| | Points | |
| Supply Chain | Financial Assessment of Options | 4 |
| Supply Chain | Damage Assessment of Options | 5 |
| Supply Chain | Competitive Assessment of Options | 6 |
| Supply Chain | 3 Year Cost Hypothesis for | 7 |
| | Energy/Gas/Dunnage/Warehousing | |
| Supply Chain | Reduction in Supply Chain Impact on CO₂ | 8 |
| Supply Chain | Reduction in Supply Chain Impact on Additional | 9 |
| | Gases and Resources | |
| Supply Chain | Best in Category Supply Chain to Limit | 10 |
| | Energy/Greenhouse Gas Use | |
| Transport Type | General Company Data | 1 |
| Transport Type | Brand Team Knowledge of Transport | 2 |
| | Inbound/Outbound | |
| Transport Type | Flow Chart of All Inputs and Transport | 3 |
| | Needs/GHG Emissions (If Known) | |
| Transport Type | Brand Uses Extensive Air Transport | 4 |
| Transport Type | Brand Uses Air and Ground Transport | 5 |
| Transport Type | Brand Uses Ground and Rail | 6 |
| Transport Type | Brand Uses Rail Majority | 7 |
| Transport Type | Improvements Inbound to Factory Possible | 8 |
| Transport Type | Improvements Outbound Factory to Retail | 9 |
| | Possible | |
| Transport Type | Lowest Emissions in Category from | 10 |
| | Field/Factory/Retail | |
| Economic Benefits Where | General Company Support | 1 |
| Produced | | |
| Economic Benefits Where | Company Helps Job Train Producers Locally | 2 |
| Produced | | |
| Economic Benefits Where | Company Provides Jobs in Community | 3 |
| Produced | | |
| Economic Benefits Where | Company Donates Money to Community | 4 |
| Produced | | |
| Economic Benefits Where | Company Employees Involved in Community | 5 |
| Produced | | |
| Economic Benefits Where | Product Production Draws on Local Skills | 6 |
| Produced | | |
| Economic Benefits Where | Factory/Factories is Minor Economic Player | 7 |
| Produced | | |
| Economic Benefits Where | Factory/Factories is Medium Economic Player | 8 |
| Produced | | |
| Economic Benefits Where | Factory/Factories is Major Economic Player | 9 |
| Produced | | |
| Economic Benefits Where | Creates More Employment than Competition | 10 |
| Produced | | |
| Social Benefits Brand | Part of Company Community Support | 1 |
| Programs | Health/Well-Being | |
| Social Benefits Brand | Part of Operating Company Special Program for | 2 |
| Programs | Sustainability | |
| Social Benefits Brand | Brand Connects through Retailer Program to | 3 |
| Programs | Sustainability | |
| Social Benefits Brand | Brand Connects Directly to Community of | 4 |
| Programs | Ingredients | |
| Social Benefits Brand | Brand Links to Broader Social Issues of | 5 |
| Programs | Health/Well-Being | |
| Social Benefits Brand | Brand Leads with Social Impact on Inputs | 6 |
| Programs | | |
| Social Benefits Brand | Brand Part of Multi-Brand Program to Benefit | 7 |
| Programs | Consumers for Health/Well-Being | |
| Social Benefits Brand | Brand Supports Health/Well-Being Programs | 8 |
| Programs | | |
| Social Benefits Brand | Brand Supports Consumers of Brand for Direct | 9 |
| Programs | Needs | |
| Social Benefits Brand | Brand Program Best in Category | 10 |
| Programs | | |
| Consumer Communication | Brand Team Knowledge of Issues | 1 |
| of Sustainability | | |
| Consumer Communication | Competitive Assessment of Sustainability | 2 |
| of Sustainability | | |
| Consumer Communication | Online Reference to Corporate Sustainability | 3 |
| of Sustainability | | |
| Consumer Communication | Online Reference to Brand's Sustainability | 4 |
| of Sustainability | | |
| Consumer Communication | Package Reference to Corporate Sustainability | 5 |
| of Sustainability | | |
| Consumer Communication | Package Reference to Brand Sustainability | 6 |
| of Sustainability | | |
| Consumer Communication | Mass Media Reference to Brand Sustainability | 7 |
| of Sustainability | | |
| Consumer Communication | Direct Media Reference to Brand Sustainability | 8 |
| of Sustainability | | |
| Consumer Communication | Interactive Media Reference to Brand | 9 |
| of Sustainability | Sustainability | |
| Consumer Communication | All Media Used, from Package to Internet | 10 |
| of Sustainability | | |
| Retailer Communication of | Brand Team Knowledge of Retailer Opportunities | 1 |
| Sustainability | | |
| Retailer Communication of | Competitive Assessment of Retail Sustainability | 2 |
| Sustainability | | |
| Retailer Communication of | Online Linkage to Brand Sustainability | 3 |
| Sustainability | | |
| Retailer Communication of | Printed Linkage | 4 |
| Sustainability | | |
| Retailer Communication of | Shelf Linkage | 5 |
| Sustainability | | |
| Retailer Communication of | Participates in Retailer Green Program Base | 6 |
| Sustainability | Level | |
| Retailer Communication of | Retailer Programs - Mid-Level Participation | 7 |
| Sustainability | | |
| Retailer Communication of | Retailer Programs - High-Level Participation | 8 |
| Sustainability | | |
| Retailer Communication of | Retailer Considers Brand as Example to Others | 9 |
| Sustainability | | |
| Retailer Communication of | Best in Class Participating in Retailer Green | 10 |
| Sustainability | Programs | |
| At Retail Communication | Brand Knowledge of Retail Opportunities | 1 |
| of Sustainability | | |
| At Retail Communication | Evaluates Current Retail Green Programs | 2 |
| of Sustainability | | |
| At Retail Communication | Evaluates New Environmental Programs | 3 |
| of Sustainability | | |
| At Retail Communication | Trial Programs at Retail | 4 |
| of Sustainability | | |
| At Retail Communication | Main Components of Retail Material | 5 |
| of Sustainability | | |
| At Retail Communication | Low Exposure at Retail | 6 |
| of Sustainability | | |
| At Retail Communication | Mid-Level Exposure at Retail | 7 |
| of Sustainability | | |
| At Retail Communication | High-Level Exposure at Retail | 8 |
| of Sustainability | | |
| At Retail Communication | Retailer Considers Brand as Example to Others | 9 |
| of Sustainability | | |
| At Retail Communication | Best in Class Retail Communication | 10 |
| of Sustainability | | |
| Consumer Use of Package | Brand Team Knowledge Use and Disposal | 1 |
| Container | | |
| Consumer Use of Package | Clear Package Markings for Use/Reuse/Disposal | 2 |
| Container | | |
| Consumer Use of Package | Evaluation of Consumer Options | 3 |
| Container | | |
| Consumer Use of Package | Trial of New Options to Improve | 4 |
| Container | | |
| Consumer Use of Package | Small Changes Implemented | 5 |
| Container | | |
| Consumer Use of Package | Moderate Changes Implemented | 6 |
| Container | | |
| Consumer Use of Package | Major Changes Implemented | 7 |
| Container | | |
| Consumer Use of Package | Retailer Communication of Change | 8 |
| Container | | |
| Consumer Use of Package | Consumer Communication of Change | 9 |
| Container | | |
| Consumer Use of Package | Measurable Savings or Disposal Tracked | 10 |
| Container | | |
| Consumer Disposal of | Brand Team Knowledge | 1 |
| Packaging after Use | | |
| Consumer Disposal of | Study of Options | 2 |
| Packaging after Use | | |
| Consumer Disposal of | Consumer Assessment | 3 |
| Packaging after Use | | |
| Consumer Disposal of | Retailer Assessment | 4 |
| Packaging after Use | | |
| Consumer Disposal of | Manufacturer Assessment | 5 |
| Packaging after Use | | |
| Consumer Disposal of | Initial Consumer Option | 6 |
| Packaging after Use | | |
| Consumer Disposal of | Consumer Input/Review | 7 |
| Packaging after Use | | |
| Consumer Disposal of | Brand Communication | 8 |
| Packaging after Use | | |
| Consumer Disposal of | Retailer Communication | 9 |
| Packaging after Use | | |
| Consumer Disposal of | Measurable Changes Tracked | 10 |
| Packaging after Use | | |
| Innovations in | Brand Team Knowledge of Issues | 1 |
| Sustainability | | |
| Innovations in | Competitive Scans | 2 |
| Sustainability | | |
| Innovations in | Tracking New Options | 3 |
| Sustainability | | |
| Innovations in | One Identified to Study | 4 |
| Sustainability | | |
| Innovations in | Two Identified to Study | 5 |
| Sustainability | | |
| Innovations in | Future Trends Assessed | 6 |
| Sustainability | | |
| Innovations in | Retailer Test Partner | 7 |
| Sustainability | | |
| Innovations in | Supplier Test Partner | 8 |
| Sustainability | | |
| Innovations in | 1st to Market | 9 |
| Sustainability | | |
| Innovations in | Game Changer | 10 |
| Sustainability | | |

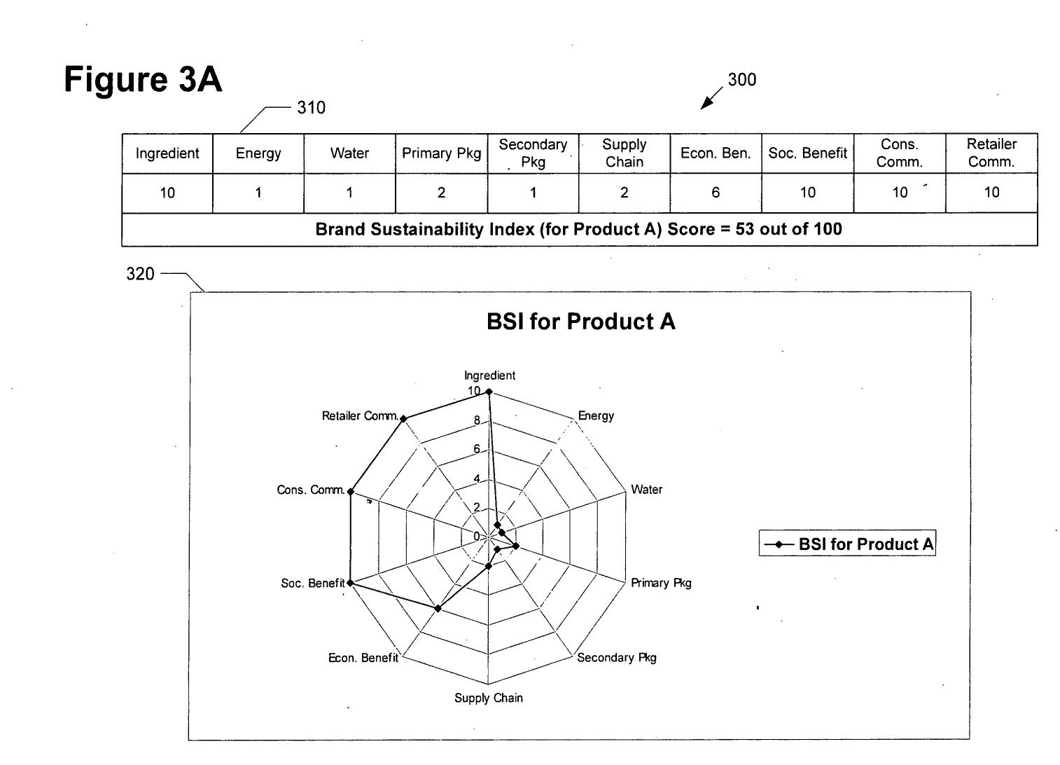

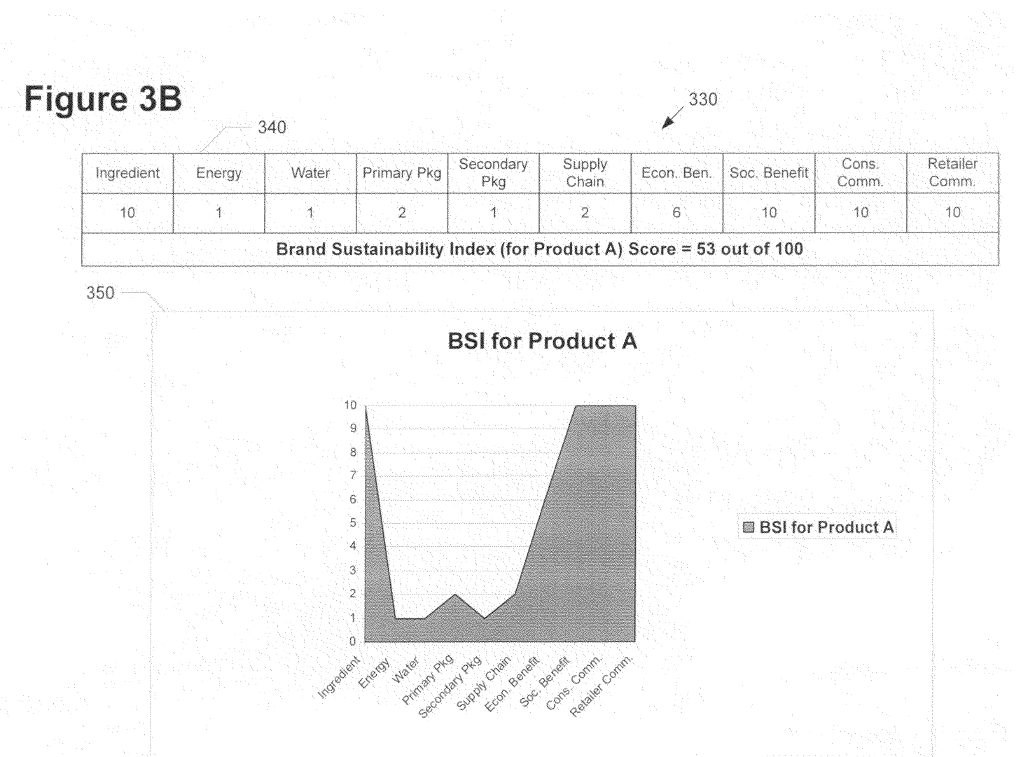

FIG. 3A illustrates an exemplary embodiment of a display of a sustainability index for a consumer brand. The display 300, shown in FIG. 3A, includes a tabular section 310 and a graphic section 320. The tabular section 310 displays the score assigned to each applicable sustainability factor for the consumer brand. As shown in FIG. 3A, the activity associated with the INGREDIENT sustainability factor was assigned a score of 10, the activity associated with the ENERGY sustainability factor was assigned a score of 1, etc. The tabular section 310 also displays a composite rating for the brand which, as shown in FIG. 3A, is “Brand Sustainability Index (for Product A) Score is 53 out of 100”. In this example, the composite rating is calculated as a simple summation of the individual scores for the applicable sustainability factors (i.e., the summation of 10, 1, 1, 2, 1, 2, 6, 10, 10, and 10) without any adjustment of the scores for weighting. The graphic section 320 illustrates the data in the tabular section 310 as a radar graph.

FIG. 3B illustrates another exemplary embodiment of a display of a sustainability index for a consumer brand. The display 330, shown in FIG. 3B, includes a tabular section 340 and a graphic section 350. The tabular section 340 is identical to the tabular section 310 shown in FIG. 3A. The graphic section 330 illustrates the data in the tabular section 310 as an area graph. Alternatively, the graphic section 330 may illustrate the data in the tabular section 310 as a line graph, bar graph, or the like.

As discussed above, one embodiment of the brand sustainability index program 141 calculates the composite rating as a simple mathematical summation of the individual scores for the applicable sustainability factors. In various other embodiments, the brand sustainability index program 141 calculates the composite rating as the mathematical product of the individual scores for the applicable sustainability factors, the mathematical average of the individual scores for the applicable sustainability factors, the mathematical weighted average of the individual scores for the applicable sustainability factors, the mathematical area of a region shown in the graphic region of the display, and the like.

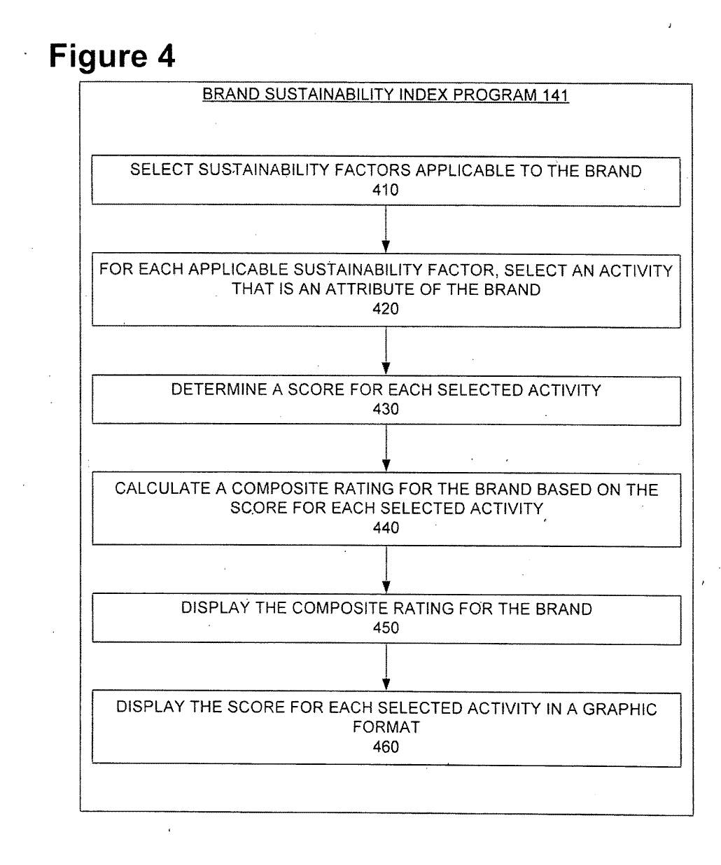

FIG. 4 is a flow diagram that illustrates an exemplary embodiment of a method for determining a composite rating for sustainability of a brand to illustrate one exemplary embodiment of the brand sustainability index program 141. As shown in FIG. 4, the processing performed by the brand sustainability index program 141 begins with selecting sustainability factors applicable to the brand (step 410). For each applicable sustainability factor, the brand sustainability program 141 then selects an activity that is an attribute of the brand (step 420) and determines a score for each selected activity (step 430). The brand sustainability index program 141 then calculates a composite rating for the brand based on the score for each selected activity (step 440). The brand sustainability index program 141 displays the composite rating for the brand (step 450) and the score for each selected activity in a graphic format (step 460), such as the formats shown in FIGS. 3A and 3B.

In another aspect, the present invention provides a means for communicating information about or instructions for using one or more methods, systems, or computer programs for determining a composite rating for sustainability for a brand. The means comprises a document, digital storage media, optical storage media, audio presentation, or visual display containing the information or instructions. In certain embodiments, the communication means is a displayed web site, visual display, kiosk, brochure, product label, package insert, advertisement, handout, public announcement, audiotape, videotape, DVD, CD-ROM, computer readable chip, computer readable card, computer readable disk, computer memory, or combination thereof containing such information or instructions. Useful information includes one or more of (1) methods and techniques for using the methods, systems, computer programs and parameters defined herein for determining a sustainability index and (2) contact information to use if an individual has a question about the invention and its use. The communication means is useful for instructing on the benefits of using the present invention and communicating the preferred methods for selecting parameters and systems for determining a sustainability index for a particular brand.

Although the disclosed exemplary embodiments describe a fully functioning system and method for determining a composite rating for sustainability of a brand, the reader should understand that other equivalent exemplary embodiments exist. Since numerous modifications and variations will occur to those reviewing this disclosure, the system and method for determining a composite rating for sustainability of a brand is not limited to the exact construction and operation illustrated and disclosed. Accordingly, this disclosure intends all suitable modifications and equivalents to fall within the scope of the claims.

1. A method for determining a composite rating for sustainability for a brand comprising:
selecting a number of sustainability factors that are applicable to the brand;
selecting an activity that is an attribute of the brand for each applicable sustainability factor;
determining a score for each selected activity;
calculating the composite rating based on the scores for the selected activities; and
displaying the composite rating.

2. The method of claim 1 wherein at least two sustainability factors are selected.

3. The method of claim 1 wherein at least three sustainability factors are selected.

4. The method of claim 1 wherein calculating the composite rating further comprises computing a mathematical summation of the scores for the selected activities.

5. The method of claim 1 wherein calculating the composite rating further comprises computing a mathematical product of the scores for the selected activities.

6. The method of claim 1 wherein calculating the composite rating further comprises computing a mathematical average of the scores for the selected activities.

7. The method of claim 1 wherein calculating the composite rating further comprises computing a mathematical weighted average of the scores for the selected activities.

8. The method of claim 1 wherein calculating the composite rating further comprises computing a mathematical area under a curve that graphically illustrates the scores for the selected activities.

9. The method of claim 1 wherein displaying the composite rating further comprises displaying a curve that graphically illustrates the scores for the selected activities.

10. A system for determining a composite rating for sustainability for a brand comprising:
a memory device resident in a computer; and
a processor disposed in communication with the memory device, the processor configured to:
select a number of sustainability factors that are applicable to the brand;
select an activity that is an attribute of the brand for each applicable sustainability factor;
determine a score for each selected activity;
calculate the composite rating based on the scores for the selected activities; and
display the composite rating.

11. The system of claim 10 wherein the processor is configured to select at least two sustainability factors.

12. The system of claim 10 wherein the processor is configured to select at least three sustainability factors.

13. The system of claim 10 wherein to calculate the composite rating, the processor is configured to compute a mathematical summation of the scores for the selected activities.

14. The system of claim 10 wherein to calculate the composite rating, the processor is configured to compute a mathematical product of the scores for the selected activities.

15. The system of claim 10 wherein to calculate the composite rating, the processor is configured to compute a mathematical average of the scores for the selected activities.

16. The system of claim 10 wherein to calculate the composite rating, the processor is configured to compute a mathematical weighted average of the scores for the selected activities.

17. The system of claim 10 wherein to calculate the composite rating, the processor is configured to compute a mathematical area under a curve that graphically illustrates the scores for the selected activities.

18. The system of claim 10 wherein to display the composite rating, the processor is configured to display a curve that graphically illustrates the scores for the selected activities.

19. A computer program product for determining a composite rating for sustainability for a brand comprising a computer readable medium storing:
program code for selecting a number of sustainability factors that are applicable to the brand;
program code for selecting an activity that is an attribute of the brand for each applicable sustainability factor;
program code for determining a score for each selected activity;
program code for calculating the composite rating based on the scores for the selected activities; and
program code for displaying the composite rating.

20. The computer program product of claim 19 wherein the program code for selecting the number of sustainability factors is configured to select at least two sustainability factors.

21. (canceled)

22. (canceled)

23. (canceled)

24. (canceled)

25. (canceled)

26. (canceled)

27. (canceled)

28. (canceled)

29. (canceled)
